(19) United States
(12) Patent Application Publication
(10) Pub. No.: US 2017/0103397 A1
(43) Pub. Date: Apr. 13, 2017

(54) VIDEO IDENTIFICATION METHOD AND COMPUTER PROGRAM PRODUCT THEREOF

(71) Applicant: MITAKE INFORMATION CORPORATION, Taipei City (TW)

(72) Inventor: Hung-Che CHIU, Taipei City (TW)

(21) Appl. No.: 14/993,657

(22) Filed: Jan. 12, 2016

(30) Foreign Application Priority Data
Oct. 8, 2015 (TW) 104133203

(51) Int. Cl. G06Q 20/40; G10L 17/08; G06K 9/00; G10L 17/24; G06K 9/52; H04N 21/21

(52) U.S. Cl. CPC G06Q 20/4014; G06K 9/52; H04N 21/21; G06K 9/00758; G06K 9/00885; G10L 17/24; G10L 17/08

(57) ABSTRACT

A video identification method and a computer program product thereof are disclosed. The method and the product are applied in a device which has a camera lens, a microphone and a monitor. The video identification method may include steps of: receiving a starting verification instruction; generating a dynamic prompt by a dynamic prompt module randomly or receiving the dynamic prompt transmitted from a server; displaying the dynamic prompt on the monitor; recording a user's video by the camera lens and the microphone simultaneously when the user reads out the dynamic prompt displayed on the monitor, where the video includes an audio track which records a sound reception of the microphone; transforming the sound reception of the microphone into a comparable data; comparing the comparable data with the data of the dynamic prompt, and accomplishing a recording process for recording the video when the comparable data matches with the data of the dynamic prompt, or displaying a speech re-recognition prompt when the comparable data does not match with the data of the dynamic prompt; and uploading the video recorded in the recording process to the server.

### 1. FIELD OF THE INVENTION

The present invention relates to an identification technology, and more particularly to a video identification method.

### 2. THE PRIOR ART

Taiwan FSC (Financial Supervisory Commission) points that in response to the great progress of the communication technology for the mobile communication, the social network, the big data and the cloud, the financial service needs to keep with the times and coordinate with the information development, so as to improve the convenience for consumers. Hence, FSC promotes a plan for building the digital financial environment 3.0 and starts the plan from 2015. For this plan, TWSE (Taiwan Stock Exchange) revises and publishes related regulations, so as to enhance the service efficiency policy for the securities firm. The securities firm can employ communication manner or electronic manner in which the applicant's identification and expression of intent can be confirmed, so that the securities film can open an account and the related supplementary measures acquired online for a new customer. TWSE indicates that when the securities firm supplies the electronic financial service to accept the request for opening the account online, the securities firm can confirm the client's identification according to following methods: the first method is that the client's identification can be identified by the transaction bank; the second method is that the client's identification can be identified by the client's original certificate of professional person, such as lawyer or accountant; the third method is that the account may be opened via the manners of the mail communication and the video after confirmation by visiting; the fourth method is that client's identification can be identified by other evidences capable of proving that the client is the applicant himself.

In views of the above identification methods, the related companies (such as the securities dealer/broker/firm and the financial information company) proposed an approach for the identification, and the approach (hereafter refer to prior arts) has following steps. The first step is installing and executing an APP on the mobile device, such as the Smartphone or the Table PC. The second step is choosing the transaction bank, inputting an account number, and uploading a photo of the bankbook to a server. The third step is filling in the individual data, and uploading a copy of the identity card to the server. The fourth step is taking a still headshot photo or having a video verification, to perform the identity verification. The fifth step is downloading the electronic certificate. In further, at the fourth step in the prior arts, after the still headshot photo or the video taken by the user's smartphone is uploaded to the server, the employee in the securities firm reviews the still headshot photo or the video for identification. However, it is easy to have a fraud problem in the prior arts. For example, a personator may use the smartphone to take another's headshot, or copy a video displayed by another smartphone, but the uploaded photo or video is not related to the personator.

In the aforesaid prior arts, only the checkers in the backstage management system can avoid the fraud problem. However, sometimes the checkers may still miss some fake applications subject to mass workload of manual verifications. Besides, the progress of the faking technology also increases the difficulty of identifying the headshot photo copy or the video copy. That is, the identity verification technology provided by the prior arts cannot meet the requirement of the financial company. As a result, it is necessary to provide a video identification technology to overcome the problems in the prior arts, so as to avoid the situation of the account opened by a personator with the fake identity.

### SUMMARY

In accordance with an aspect of the present invention, a video identification method and a computer program product thereof are provided. In the video identification method, the identification is performed by a video which is recorded by using a camera lens and a dynamic prompt displayed on a monitor, so as to avoid the image copying.

The present invention provides a video identification method which is applied to a device. The device has a camera lens, a microphone and a monitor. The video identification method includes steps of: receiving a starting verification instruction; randomly generating a dynamic prompt by a dynamic prompt module or receiving the dynamic prompt transmitted from a server; displaying the dynamic prompt on the monitor; recording a user's video by the camera lens and the microphone simultaneously when the user reads out the dynamic prompt displayed on the monitor, where the video includes an audio track and the audio track records a sound reception of the microphone; transforming the sound reception of the microphone into a comparable data; comparing the comparable data with the data of the dynamic prompt, and accomplishing a recording process for recording the video when the comparable data matches with the data of the dynamic prompt, or displaying a speech re-recognition prompt when the comparable data does not match with the data of the dynamic prompt; and uploading the video recorded in the recording process to the server.

Moreover, the present invention further provides a computer program product installed on a device which has a camera lens, a microphone, a monitor and a memory. The computer program product includes a data transmission module, a dynamic prompt module, a video recording module and a speech recognition module. The data transmission module establishes a connection with a server to transmit data. The dynamic prompt module provides a dynamic prompt. The video recording module captures a video of a user by the camera lens and turns on the microphone to record a sound reception of the microphone and saves as an audio track of the video, and then stores the recorded video into the memory. And, the speech recognition module transforms the sound reception of the microphone into a comparable data by a speech recognition engine and compares the comparable data with the data of the dynamic prompt. The speech recognition module accomplishes the recording process for recording the video when the comparable data matches with the data of the dynamic prompt, or displays a speech re-recognition prompt when the comparable data does not match with the data of the dynamic prompt. In addition, the computer program product may display the dynamic prompt on the monitor and record the video by the camera lens and the microphone according to a starting verification instruction, and may trigger the data transmission module to upload the video recorded in the recording process to the server according to an upload instruction.

In addition, the present invention further provides a computer readable recording medium for recording an application program. The application program is installed on a device having a camera lens, a microphone, a monitor and a memory. The application includes a data transmission module, a dynamic prompt module, a video recording module and a speech recognition module. The data transmission module establishes a connection with a server to transmit data. The dynamic prompt module provides a dynamic prompt. The video recording module captures a video of a user by the camera lens and turns on the microphone to record a sound reception of the microphone and saves as an audio track of the video, and then stores the recorded video into the memory. And, the speech recognition module transforms the sound reception of the microphone into a comparable data by a speech recognition engine and compares the comparable data with the data of the dynamic prompt. The speech recognition module accomplishes a recording process for recording the video when the comparable data matches the data of the dynamic prompt, or displays a speech re-recognition prompt when the comparable data does not match with the data of the dynamic prompt. In addition, the application program may display the dynamic prompt on the monitor and record the video by the camera lens and the microphone according to a starting verification instruction, and may trigger the data transmission module to upload the video recorded in the recording process to the server according to an upload instruction.

### BRIEF DESCRIPTION OF THE DRAWINGS

FIG. 1 is a functional block diagram of a video identification device according to an embodiment of the present invention.

FIG. 2 is a functional block diagram of an application program according to an embodiment of the present invention.

FIG. 3 is a first view of displaying a dynamic prompt on a monitor according to an embodiment of the present invention.

FIG. 4 is a second view of displaying a dynamic prompt on a monitor according to an embodiment of the present invention.

FIG. 5 is a third view of displaying a dynamic prompt on a monitor according to an embodiment of the present invention.

FIG. 6 is a fourth view of displaying a dynamic prompt on a monitor according to an embodiment of the present invention.

FIG. 7 is a fifth view of displaying a dynamic prompt on a monitor according to an embodiment of the present invention.

FIG. 8 is a sixth view of displaying a dynamic prompt on a monitor according to an embodiment of the present invention.

FIG. 9 is a flow chart according to an embodiment of the present invention.

### DETAILED DESCRIPTION OF THE PREFERRED EMBODIMENTS

Reference will now be made in detail to the exemplary embodiments of the present invention, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

In an embodiment, the present invention may include, but not limited to, PC, Laptop, Notebook, Portable Computer, Smartphone and Tablet PC; however, any device with a monitor, a microphone and a camera lens may be applied to the video identification method and computer program product thereof of the present invention. In particular, the camera lens and the monitor have to be disposed on the same side of the device and face towards the user, so as to facilitate the user to read out a dynamic prompt shown on the monitor and record a video at the same time. For example, the front-facing camera and the monitor of the notebook, the smartphone and the tablet pc are arranged on the same side, or a webcam is disposed on the monitor of the PC. Regarding the camera lens, the present invention can be applied to an apparatus having lens to capture dynamic images, and including the software and the hardware to record the dynamic images as a video. The device equivalent to the camera lens includes the photographic lens, the video camera, the camera, the network video camera, camcorder, video cam and webcam.

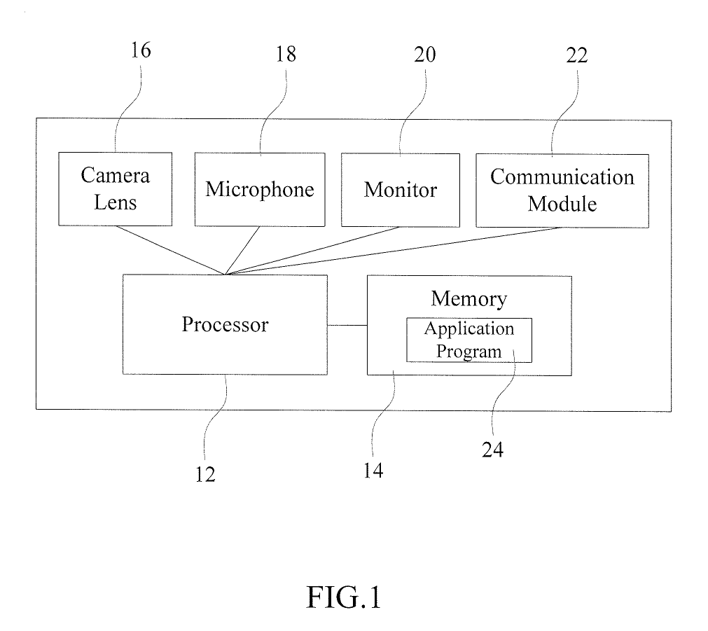

Please refer to FIG. 1, which is a functional block diagram of a video identification device 10 according to an embodiment of the present invention. The figure only illustrates core modules of the embodiment of the present invention, and other modules of the embodiment are omitted in the figure for the sake of simplicity. An application program 24 is executed on the video identification device 10 of the present invention. In the embodiment of the present invention, the video identification device 10 includes at least one processor 12, a memory 14, a camera lens 16, a microphone 18, a monitor 20 and a communication module 22. The application program 24 is stored in the memory 14. The processor 12 executes plural program instructions of the application program 24, and cooperates with the software and the hardware to practice plural modules including a data transmission module 26, a dynamic prompt module 28 and a video recording module 30. The camera lens 16 is configured to capture the user's headshot, bust or full-length image, so as to make a video. The microphone 18 is used to receive sound, and more particularly to the user's voice. The monitor 20 displays an interface of the application program 24. The communication module 22 establishes a connection to Internet, and the connection could be Cable, Wireless LAN (WiFi), or the mobile communication network (3G and 4G).

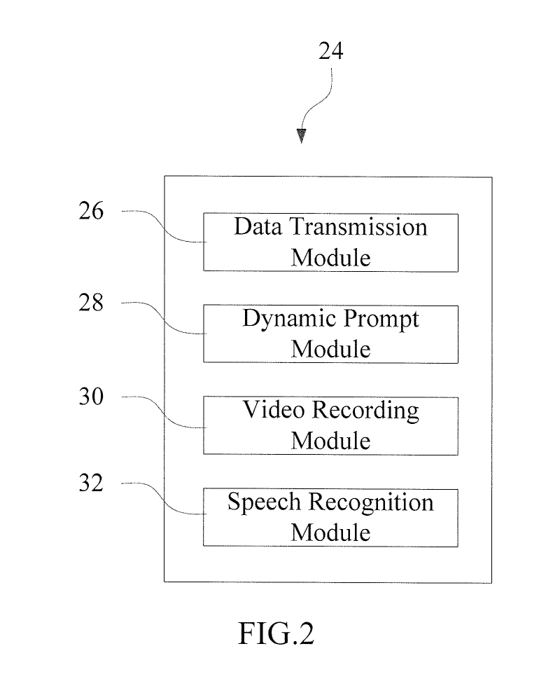

Please refer to FIG. 2, which is a functional block diagram of an application program 24 according to an embodiment of the present invention. The data transmission module 26 is connected to a remote server (hereafter refer to a server) to transmit data by Internet established by the communication module 22. The data uploaded to the server may include the video, the dynamic prompt, the photo of the identity card, the photo of the bankbook, or the individual data, where the dynamic prompt is generated from the client side and the individual data is generated from an online registration. The data received from the server may include the dynamic prompt which is generated by the server. In some embodiments of the present invention, the data received from the server may include the financial instruments quotation data, the bank accounts data, the electronic questionnaires/voting data, the electronic ticket/voucher data, or the social network member's data. In other words, the application program 24 may be the financial instruments quotation software, the network bank software, the electronic questionnaires/voting software or the electronic ticket/voucher software. The dynamic prompt module 28 may randomly generate the dynamic prompt on a client side (that is, the video identification device 10), or receive the dynamic prompt generated by the server via the data transmission module 26. Here, the dynamic prompt is similar to a dynamic password because the dynamic prompts are different for different video recordings, respectively. The data of the dynamic prompt may be writings/characters, numbers, or figures/pictures/icons which could be identified. For example, the content may be a circle, a rectangle, a triangle, an up/down/left/right arrow symbol, a laughing face icon, a crying face icon, a lightning icon, a cloud icon, a rain icon or a sun icon. The video recording module 30 utilizes the camera lens 16 and the microphone 18 to make the video which may be saved in the AVI, MOV or MPG file format. The camera lens 16 is used to capture the user's headshot, bust or full-length image, to make the video, and the microphone 18 is turned on to record the received sound into an audio track of the video. Then, the video recorded in above recording process is stored into the memory 14.

When the user starts operating to the present video identification device 10 to record the video and upload the recorded video to the server for identifying the identification, a starting verification instruction is executed for beginning the recording process. For example, the user can press the “Recording Button” of the application program 24 (not shown in FIGs); or choose the “Recording Menu-Item” by operating a menu for the application program 24 (not shown in FIGs). The recording process may include steps of generating the dynamic prompt generated by the client side or receiving the dynamic prompt generated by the server side, showing the dynamic prompt on the monitor, and starting the camera lens 16 and the microphone 18 up. Next, the user must read out the dynamic prompt displayed on the monitor 20 by his/her mouth. When the video is being recorded, the speech recognition module 32 of the present invention may perform the data transformation and the data comparison at the same time. When the content of received sound with respect to the dynamic prompt read out by the user matches with the data of the dynamic prompt shown on the monitor (that is, the content of received sound is identical to the dynamic prompt), the recording process for recording the video is completed, and the video recorded in the recording process is stored into the memory 14.

In another embodiment of the present invention, the user may use a stop recording instruction to stop the recording process, for example, the user can press a “Stop Recording Button” of the application program 24 (not shown); and then the video is generated and stored into the memory 14. Finally, the user may use an upload instruction, for example, the user may press an “Upload Video Button” of the application program 24, to upload the recorded video to the server by the data transmission module 26.

One of the major technical features of the present invention is that the self-taken video of the user includes the data of the sound read out by the user according to the dynamic prompt shown on the monitor. The server may save each of the dynamic prompt (the dynamic prompt generated from the client side is also uploaded to the server), so the video containing the data of the sound read out by the user according to the dynamic prompt shown on the monitor can prove the authenticity of that video, that is, the video can be proved not fake one. In some embodiments of the present invention, after the user uploads the video to the server, the checkers at the backstage management system will perform a review process for identification. For example, the checkers may verify if the content read out by the user according to the dynamic prompt in the video matches with the data of the dynamic prompt on the server.

The speech recognition module 32 of the present invention is configured to run a speech recognition engine (not shown) to transform the sound reception of the microphone 18 into the comparable data, and then compare the comparable data with the data of the dynamic prompt on the monitor. The speech recognition module may accomplish the recording process for recording the video when the comparable data matches with the data of the dynamic prompt, or a speech re-recognition prompt will be displayed on the monitor when the comparable data does not match with the data of the dynamic prompt. That is, the speech recognition module 32 of the present invention fetches the sound reception of the microphone 18 to perform a sound certification, so as to realize the auto-identification function. By verifying the immediate sound certification, the present invention can not only prevent the problem of the video made by the personator, but reduce the cost of the manual operations of the checkers. Furthermore, a fully auto-identification may be achieved, and that is the other major technical feature of the present invention. In an embodiment of the present invention, the speech recognition engine can be disposed on the client side, and the transformation process and the comparison process are performed on the client side directly. In an embodiment of the present invention, the speech recognition engine can be disposed on the server or the cloud, the transformation process and the comparison process are performed on the server/cloud after the received sound is uploaded to the server/cloud.

In another embodiment, after comparison between the data of the sound reception of the microphone with the data of the dynamic prompt, a score may be generated for determining the comparison process. When the score is higher than or equal to a default value, it is determined as coincidence. For example, when the default is 70%, it will be determined as the coincidence (i.e., matched) if there are ten words in the dynamic prompt and seven to ten words could be identified successfully. When the score is less than the default, it is determined as non-coincidence (i.e., not matched), and a speech re-recognition prompt is generated and displayed. The default may be set from 30% to 100%. The objective of the present invention is to solve the problem of identifying the user and not to solve the problem of performing the speed recognition to be 100%, so this indistinct determination method can effectively increase the identification efficiency.

In the different embodiments of the present invention, each of the aforesaid modules should be regarded as a resource in cooperation with the software and the hardware. The technical feature of each of the modules may be expressed by a portion of plural program instructions or the application program, and the technical effect of each module needs to be implemented by using at least one processor to execute the program instructions or the application program. By using the resource cooperated by the software and the hardware, the drawbacks in the prior arts may be improved.

In another embodiment, the present invention also provides a computer program product installed on a device which is shown in FIG. 1, where the device has a camera lens, a microphone, a monitor and a memory. The computer program product includes all modules of the application program 24 in FIG. 2, such as the data transmission module 26, the dynamic prompt module 28, the video recording module 30 and the speech recognition module 32. The computer program product displays the dynamic prompt on the monitor and records the video by the camera lens and the microphone according to a starting verification instruction. And, the computer program product further triggers the data transmission module to upload the video to the server according to an upload instruction.

In another embodiment, the present invention also provides a computer readable recording medium for recording the application program 24 in FIG. 2. The application program 24 is installed on the device equipped with the camera lens, the microphone, the monitor and the memory (that is, the device shown in FIG. 1). The application program includes the data transmission module 26, the dynamic prompt module 28, the video recording module 30 and the speech recognition module 32. The application program 24 displays the dynamic prompt on the monitor and records the video by the camera lens and the microphone according to the starting verification instruction, and the application program 24 triggers the data transmission module to upload the video recorded in the recording process to the server according to the upload instruction.

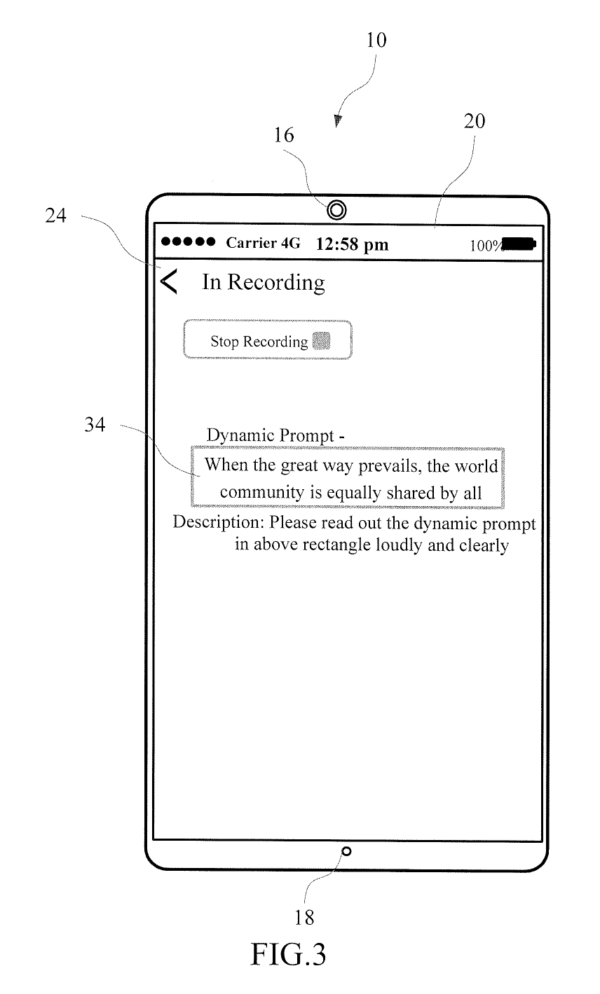

Please refer to FIGS. 3 through 7, which are views of displaying a dynamic prompt on a monitor 20 according to an embodiment of the present invention. The figures show the dynamic prompt and the possible format thereof displayed on the monitor 20 according to some preferred embodiments of the present invention. The camera lens 16 and the monitor 20 of the video identification device 10 have to be disposed on the same side, which is facing to the user, such that the user may read out the dynamic prompt 34 displayed on the monitor 20 while the video is being recorded. In these FIGs, the monitor on the smartphone is taken as examples, but the present invention does not limit thereto. The present invention may also be applied to PC, Notebook or Tablet PC.

FIG. 3 illustrates that the dynamic prompt 34 shown on the monitor 20 is a sentence according to the embodiment of the present invention. According to the dynamic prompt 34, the user should read out “When the great way prevails, the world community is equally shared by all”. In addition, the other foreign sentence, a combination of characters, or a combination of the foreign characters may also be used in the present embodiment.

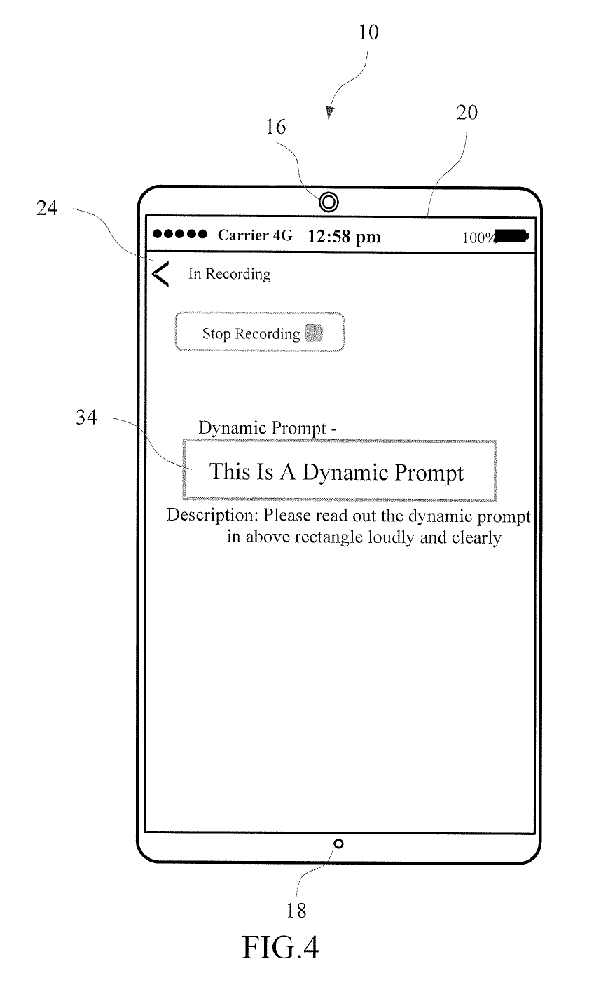

FIG. 4 illustrates that the dynamic prompt 34 shown on the monitor 20 is another sentence according to the embodiment of the present invention. According to the dynamic prompt 34, the user should read out “This Is a Dynamic Prompt”. In addition, the words without any context (i.e., no meaningful sentence) may also be used in the present embodiment.

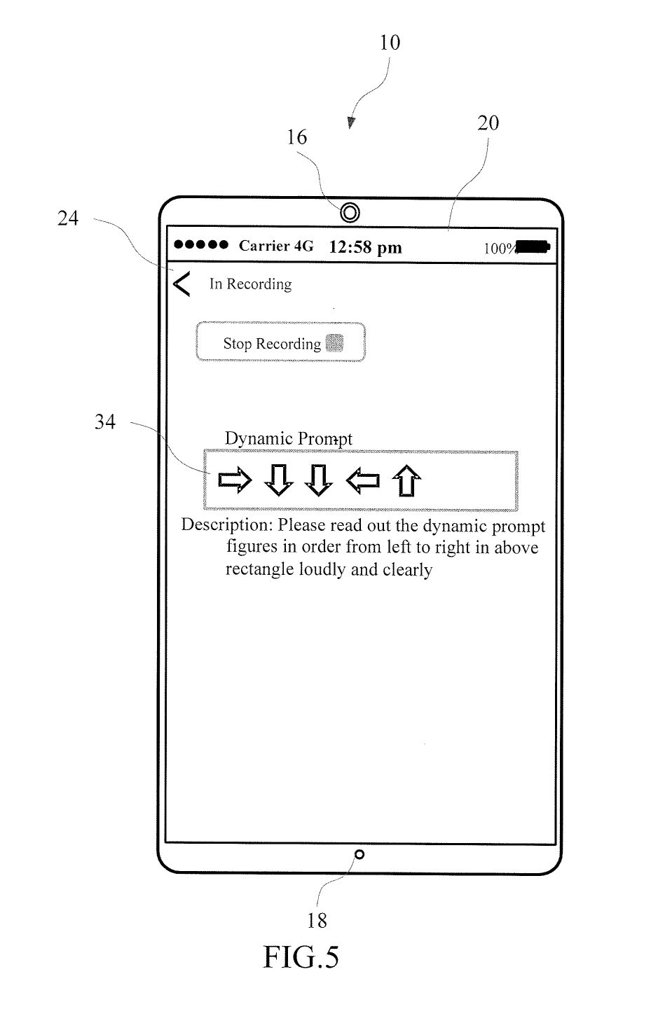

FIG. 5 illustrates that the dynamic prompt 34 shown on the monitor 20 are figures (direction arrows) according to the embodiment of the present invention. According to the figures, the user should read out “Right, Down, Down, Left, Up” or “Right Side, Down Side, Down Side, Left Side, Up Side”. The embodiment may also include others symbols, icons or figures containing the identified directions.

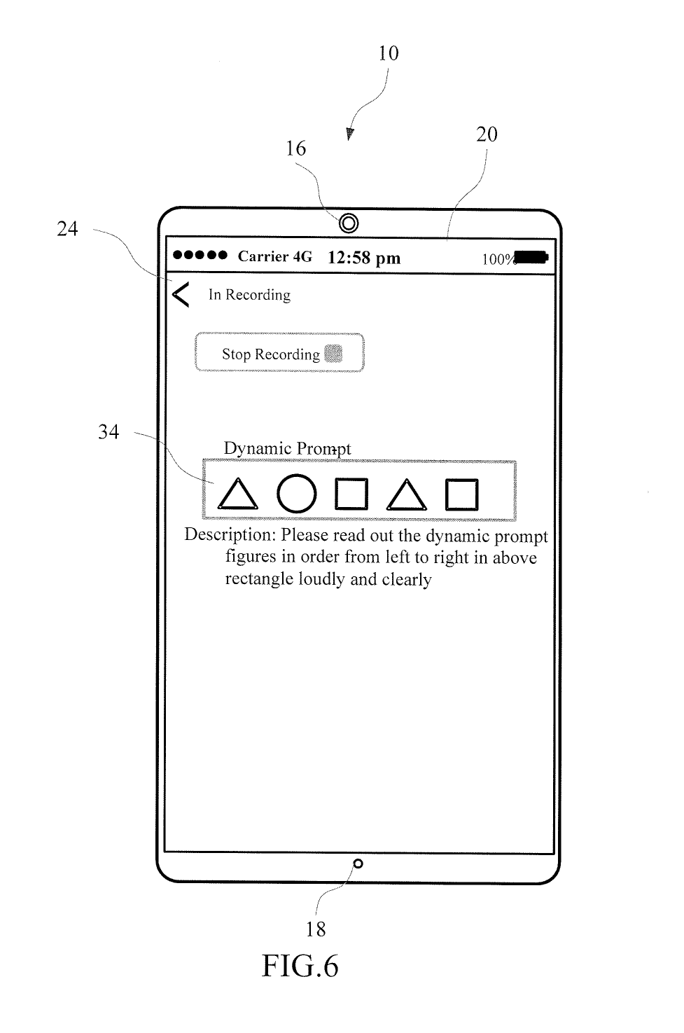

FIG. 6 illustrates that the dynamic prompt 34 shown on the monitor 20 are figures (shapes icons) according to the embodiment of the present invention. According to the figures, the user should read out “Triangle, Circle, Tetragon, Triangle, Tetragon” or “Triangle shape, Circle shape, Tetragon shape, Triangle shape, Circle shape”. The embodiment may also include others different figures/pictures/icons containing the identified shapes.

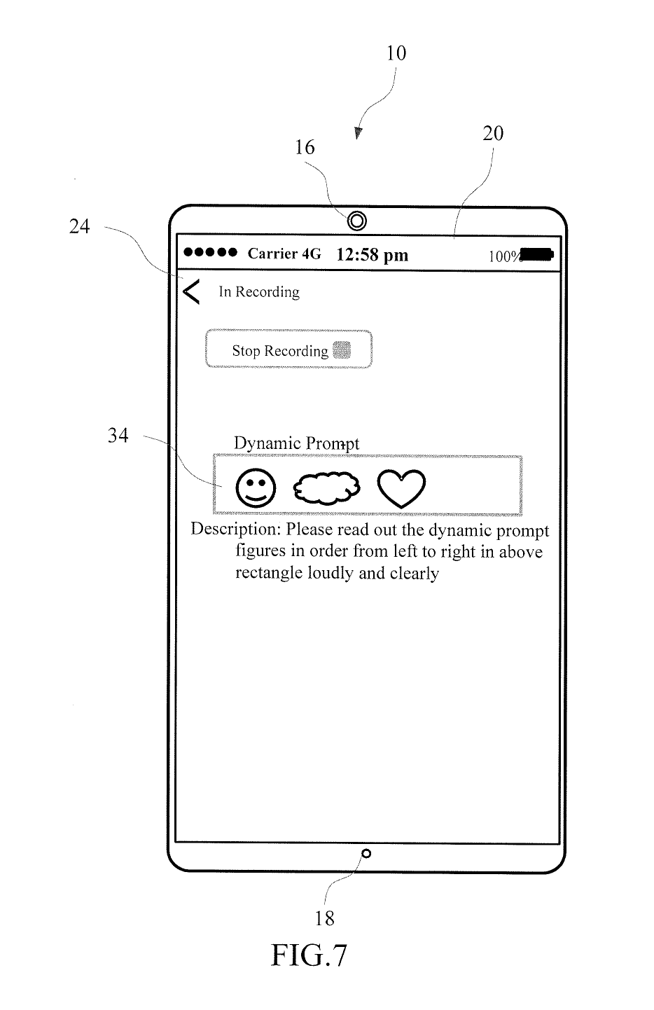

FIG. 7 illustrates that the dynamic prompt 34 shown on the monitor 20 are figures (emoji icons) according to the embodiment of the present invention. According to the figures, the user should read out “Laughing Face, Cloud, Heart” or “Laughing Face, Clouds, Heart shape”. The embodiment may also include others different figures/pictures/icons containing the identified meanings.

Except the aforesaid embodiments, in the others embodiment of the present invention, the whole dynamic prompt 34 is not shown on the monitor 20 once and the dynamic prompt 34 may be shown by words or in batches (i.e., carousel). For example, only one word/symbol/figure/icon of the whole dynamic prompt 34 is displayed for every time (not shown), only two words/symbols/figures/icons of the whole dynamic prompt 34 are displayed for every time (not shown), or only three words/symbols/figures/icons of the dynamic prompt 34 are displayed for every time (not shown). The aforementioned dynamic prompt 34 “When the great way prevails, the world community is equally shared by all” is taken as for example, when the embodiment of the present invention displays the dynamic prompt 34 by words on the monitor 20, that is, only one word is displayed for every time, the dynamic prompt 34 will be separated into thirteen prompts on the monitor for displays. By such manners, the method of the present invention can increase the difficulty of making the copy image or the fake image.

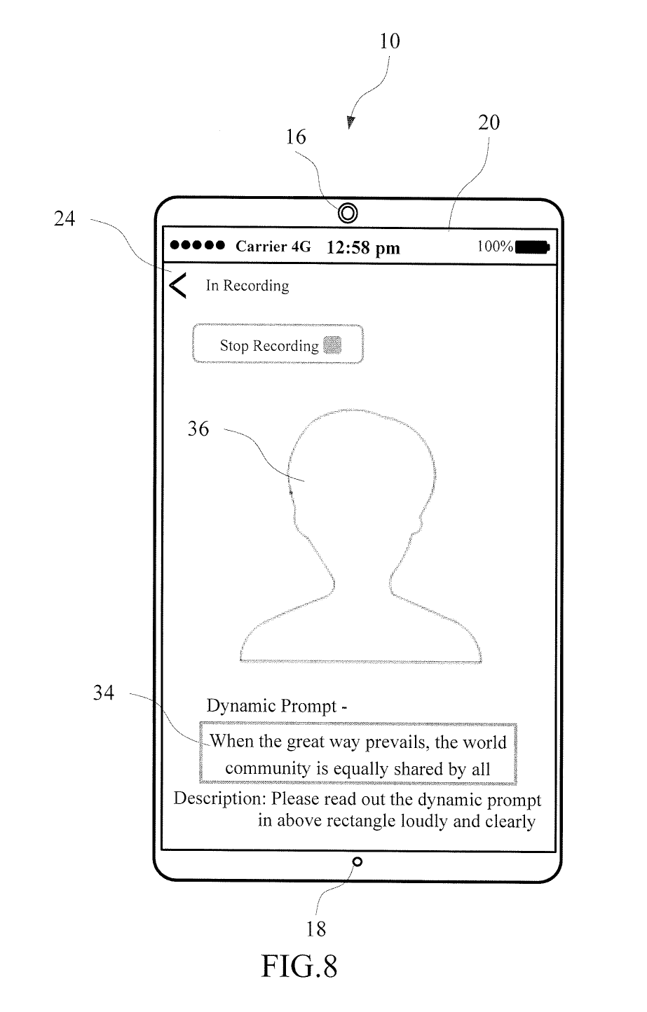

Please refer to FIG. 8, which is a view of the dynamic prompt 34 and the user image 36 shown on the monitor 20 according to another embodiment of the present invention. The embodiment not only displays the dynamic prompt 34 on the monitor 20, but also displays the user image 36 captured currently by the camera lens 16 by the user, so as to facilitate the user to check the recording quality immediately.

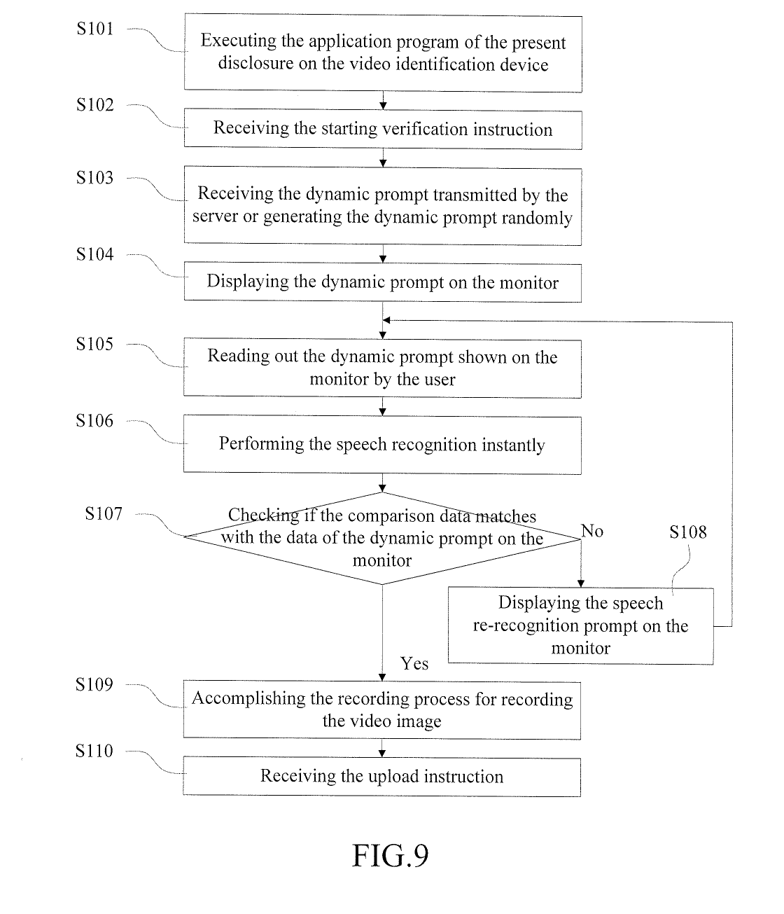

Please refer to FIG. 9, which is a flow chart according to an embodiment of the present invention. In the method, a user can operate a mobile device, such as Smartphone, Tablet PC, PC or Notebook to execute the application program 24, record a self-taken video and read out the dynamic prompt, and then upload the video after having the speech recognition process. The detailed steps of the operation flow of the present invention are described below.

In a step S101, the application program 24 of the present invention is executed on the video identification device 10. The user executed the application program 24 on a mobile device, such as Smartphone, Tablet PC, PC or Notebook.

In a step S102, a starting verification instruction is received. The user may press the “Recording Button” of the application program 24 (not shown) or choose the “Recording Menu-Item” on a menu (not shown) to generate the starting verification instruction.

In a step S103, the dynamic prompt transmitted is received by the server or generating the dynamic prompt randomly. After the application program 24 receives the starting verification instruction, the video recording module 30 starts the camera lens 16 and the microphone 18 up, and the application program 24 requests a dynamic prompt from the dynamic prompt module 28. In an embodiment of the present invention, the dynamic prompt is generated on the video identification device 10 by the dynamic prompt module 20 in a random manner. In another embodiment of the present invention, the dynamic prompt is generated on the server, and the dynamic prompt module 28 obtains the dynamic prompt from the server through the data transmission module 26.

In a step S104, the dynamic prompt is displayed on the monitor 20. After the dynamic prompt module 28 generates or receives the dynamic prompt, the dynamic prompt 34 will be displayed on the monitor 20, as exemplarily shown in FIGS. 3 through 7.

In a step S105, the dynamic prompt 34 shown on the monitor 20 is read out by the user. When the dynamic prompt 34 is displayed on the monitor 20, the video recording module 30 has started the camera lens 16 and the microphone 18 up. When the user reads out the dynamic prompt 34 shown on the monitor 20, the video and the sound of the user is recorded by the video recording module 30. In some embodiments of the present invention, the step may further includes using a timer (not shown in FIGs) and a microphone volume detection module (not shown in FIGs), so as to limit the recording time. For example, if the microphone 18 does not detect any sound within 20 seconds or the volume is not louder enough (for example, only environmental noise is detected but not the use's sound), the recording process will be stopped immediately.

In a step S106, the speech recognition is performed instantly. When the microphone 18 detects the volume in the previous step, the speech recognition module 32 performs a speech recognition engine to transform the sound reception of the microphone 18 to the comparable data, and then compares the comparable data with the data of the dynamic prompt 34 on the monitor 20.

In a step S107, it is checked if the comparable data matches with the data of the dynamic prompt 34 on the monitor 20. The step S109 will be performed if the speech recognition module 32 determines the comparison result to be “YES”. The step S108 will be performed if the speech recognition module 32 determines the comparison result to be “NO”. Similarly, the comparison result may be determined by a scoring manner, where the score is generated after the comparable data is compared with the data of the dynamic prompt 34. When the score is higher than or equal to a default, the comparison result is “YES”; and when the score is less than the default, the comparison result is “NO”, so that the indistinct comparison can be realized.

In a step S108, the speech re-recognition prompt is displayed on the monitor 20 when the comparable data does not match with the data of the dynamic prompt. For example, the speech re-recognition prompt may be “Please Read out the Dynamic Prompt Shown on the Monitor.” In other embodiment of the present invention, when the speech recognition module 32 determines that the comparable data does not match with the data of the dynamic prompt in the step S107 (that is, failure of recognition), the dynamic prompt module 28 may provide another different dynamic prompt.

In a step S109, the recording process for recording the video is completed when the comparable data matches with the data of the dynamic prompt. The video recording module 30 terminates the execution automatically (that is, the user does not need to stop the recording process manually, and the recording process will be stopped immediately when the recording process is completed). And, the video recorded in the recording process is stored into the memory 14. In some embodiments of the present invention, the recording process is not stopped until the video recording module 30 receives a stop recording instruction. For example, the user presses a “Stop Recording Button” of the application program 24. In some embodiments of the present invention, a successful verification code is generated by the speech recognition module 32 automatically after the recording process is completed. For example, the successful verification code may be a tag, a flag or an independent file attached to the video. The successful verification code will be uploaded to the server with the video, so as to provide the server for having an auto-identification. According to the above different embodiments, the recording process of the present invention may be terminated automatically after it is checked if the comparable data matches with the data of the dynamic prompt 34; or, the user press the stop recording button manually to terminate the recording process.

In a step S110, an upload instruction is received. After accomplishing the recording process, the user may press the “Upload Video Button” (not shown in FIGs) to generate the upload instruction. Upon receipt of the upload instruction, the application program 24 triggers the data transmission module 26 to upload the video in the memory 14 to the server. In some embodiments of the present invention, the upload instruction will be generated automatically after the step S109. That is, the user do not need to upload the video to the server manually.

For the different embodiments of the present invention, it may be understood that the computer may execute the program instructions to implement each block diagram, each combination and each step of the flow chart. The program instructions may be applied to a processor to generate a machine or a resource which is cooperated by the software or the hardware. Thus, when the program instructions are executed by the processor, the implementation for the expected operations or the expected technical effects pointed by the flow chart may be generated. The program instructions of different sets may also make some steps of the flow charts be executed in parallel, and the technical contents indicated by each of the program instructions of the application program may vary with the different embodiments. Furthermore, the steps may be executed by at least one processor. For example, the steps may be executed by a micro-processor and a processor of the peripheral device cooperatively. Besides, Fully align with the claims of the present invention, the at least one block diagram or the combination of the block diagrams of the flow chart may be executed with others block diagrams or the combination of the others block diagrams simultaneously, or they may be executed in an different order shown in the present invention.

Therefore, the block diagram of the flow chart of the present invention is used for indicating the component combination of the operations or the technical effects, the combination of the steps of the operations or the technical effects, and the program instructions components of the operations or the technical effects. It may also be understood that the indicated operations or the technical features operated by a specific hardware system or a hardware system cooperated with the program instructions are used in implementing each block diagram and the combination of the block diagrams of the flow chart.

In summary, a video identification technology of the present invention is proposed to overcome the problem of the headshot copy or the video copy in the prior arts. By the technology of the present invention, the situation of the account opened by the personator with the fake identity can be avoided, and the manpower requirement in the backstage management system for identification may be reduced as well. As a result, the drawbacks exist in the prior arts may be improved.

The above-mentioned descriptions represent merely the exemplary embodiment of the present invention, without any intention to limit the scope of the present invention thereto. Various equivalent changes, alternations or modifications based on the claims of present invention are all consequently viewed as being embraced by the scope of the present invention.

1. A video identification method, applied in a device which comprises a camera lens, a microphone and a monitor, and the video identification method comprising:
receiving a starting verification instruction;
generating a dynamic prompt;
displaying the dynamic prompt on the monitor;
using the camera lens and the microphone to record a user's video simultaneously when the user reads out the dynamic prompt on the monitor, wherein the video comprises an audio track and the audio track records a sound reception of the microphone;
transforming the sound reception of the microphone into a comparable data;
comparing the comparable data with a data of the dynamic prompt, and then accomplishing a recording process for recording the video when the comparable data matches with the data of the dynamic prompt, or displaying a speech re-recognition prompt when the comparable data does not match with the data of the dynamic prompt; and
uploading the video recorded in the recording process to a server.

2. The video identification method of claim 1, wherein the step of generating the dynamic prompt comprises a step of generating the dynamic prompt on the device randomly, or a step of receiving the dynamic prompt generated by the server through a communication module.

3. The video identification method of claim 1, wherein the step of displaying the dynamic prompt on the monitor comprises a step of displaying whole data of the dynamic prompt once, a step of displaying the data of the dynamic prompt by words, or a step of displaying the data of the dynamic prompt in batches.

4. The video identification method of claim 1, wherein in a condition that the comparable data matches with the data of the dynamic prompt, a successful verification code is generated automatically and uploaded to the server with the video recorded in the recording process, to be used for an auto-identification.

5. The video identification method of claim 1, further comprising:
generating a score according to a result of comparing the comparable data with the data of the dynamic prompt;
determining that the comparable data matches with the data of the dynamic prompt when the score is higher than or equal to a default; and
determining that the comparable data does not match with the data of the dynamic prompt when the score is lower than the default.

6. A computer program product, applied to be installed a device which comprises a camera lens, a microphone, a monitor and a memory, and the computer program product comprising:
a data transmission module configured to establish a connection to a server, so as to transmit data;
a dynamic prompt module configured to provide a dynamic prompt;
a video recording module configured to capture a video of a user by the camera lens and turning on the microphone to record a sound reception of the microphone to an audio track of the video, and storing the video recorded in above recording process into the memory; and
a speech recognition module configured to transform the sound reception of the microphone into a comparable data by a speech recognition engine, compare the comparable data with a data of the dynamic prompt, and accomplish the recording process for recording the video when the comparable data matches with the data of the dynamic prompt, or display a speech re-recognition prompt when the comparable data does not match with the data of the dynamic prompt;
wherein the computer program product displays the dynamic prompt on the monitor and records the video by the camera lens and the microphone according to a starting verification instruction, and the computer program product triggers the data transmission module to upload the video in the memory to the server according to an upload instruction.

7. The computer program product of claim 6, wherein the dynamic prompt is provided by a manner of generating the dynamic prompt randomly by the computer program product on the device, or a manner of receiving the dynamic prompt transmitted from the server through the data transmission module.

8. The computer program product of claim 6, wherein in a condition that the comparable data matches with the data of the dynamic prompt, a successful verification code is generated by the speech recognition module automatically and uploaded to the server with the video recorded in the recording process, to be used for an auto-identification.

9. The computer program product of claim 6, wherein the dynamic prompt is displayed on the monitor by a manner of displaying whole data of the dynamic prompt once, a manner of displaying the data of the dynamic prompt by words, or a manner of displaying the data of the dynamic prompt in batches.

10. The computer program product of claim 6, wherein the speech recognition module further generates a score according to a result of comparing the comparable data with the data of the dynamic prompt, and the speech recognition module determines that the comparable data matches with the data of the dynamic prompt when the score is higher than or equal to a default or determines that the comparable data does not match the data of the dynamic prompt when the score is lower than the default.

11. A computer readable recording medium applied to record an application program installed on a device, the device comprising a camera lens, a microphone, a monitor and a memory, and the application program comprising:
a data transmission module configured to establish a connection to a server, so as to transmit data;
a dynamic prompt module configured to provide a dynamic prompt;
a video recording module configured to capture a video of a user by the camera lens, turn on the microphone to record a sound reception of the microphone to an audio track of the video, and then store the video into the memory; and
a speech recognition module configured to transform the sound reception of the microphone into a comparable data by a speech recognition engine, and compare the comparable data with a data of the dynamic prompt, wherein the speech recognition module completes the recording process for recording the video when the comparable data matches with the data of the dynamic prompt, or displays a speech recognition prompt again when the comparable data does not match with the data of the dynamic prompt;
wherein the application program displays the dynamic prompt on the monitor and records the video by the camera lens and the microphone according to a starting verification instruction, and the application program triggers the data transmission module to upload the video recorded in the recording process to the server according to an upload instruction.

12. The computer readable recording medium of claim 11, wherein the dynamic prompt is provided by a manner of generating the dynamic prompt randomly by the computer program product on the device, or a manner of receiving the dynamic prompt transmitted from the server through the data transmission module.

13. The computer readable recording medium of claim 11, wherein in a condition that the comparable data matches with the data of the dynamic prompt, a successful verification code is generated by the speech recognition module automatically and uploaded to the server with the video recorded in the recording process, to be used for an auto-identification.

14. The computer readable recording medium of claim 11, wherein the dynamic prompt is displayed by a manner of displaying whole data of the dynamic prompt once, a manner of displaying the data of the dynamic prompt by words, or a manner of displaying the data of the dynamic prompt in batches.

15. The computer readable recording medium of claim 11, wherein the speech recognition module further generates a score according to a result of comparing the comparable data with the data of the dynamic, the speech recognition module determines that the comparable data matches with the data of the dynamic prompt when the score is higher than or equal to a default, or determines that the comparable data does not match with the data of the dynamic prompt when the score is lower than the default.
